(19) United States
(12) Patent Application Publication
(10) Pub. No.: US 2008/0259538 A1
(43) Pub. Date: Oct. 23, 2008

(54) Foldable input apparatus

(75) Inventors: Jung-Wen Chang, Taoyuan County (TW); Yi-Chun Lin, Yonghe City (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 11/907,788

(22) Filed: Oct. 17, 2007

(30) Foreign Application Priority Data
Apr. 18, 2007 (TW) 096206175

(51) Int. Cl. G06F 1/16

(52) U.S. Cl. 361/680

(57) ABSTRACT

The invention discloses a foldable input apparatus including a base, a holding plate and an input module. The base has a first surface, and a first key set is disposed on the first surface. The first holding plate has a second surface and a third surface. The first holding plate is pivotally connected with the base so that the first holding plate can rotate with respect to the base. The second key set is disposed on the second surface. A recess is formed on the third surface and a circuit board is disposed in the recess. The first input module is detachably disposed in the recess, so as to electrically connect with the first circuit board. When the foldable input apparatus is unfolded, the first and the second key sets can be operated for inputting data. When the foldable input apparatus is folded, the first input module can be operated.

### BACKGROUND OF THE INVENTION

1. Field of the Invention

The invention relates to a foldable input apparatus and, more particularly, to a foldable input apparatus with detachable input modules.

2. Description of the Prior Art

With massive information and progressive technology, there is a strong need for more portable electronic apparatuses. It is a strict test to design a product with multiple functions under the restriction of limited space and weight. To satisfy user's need for inputting data, some small-sized keypads are provided in portable electronic apparatus. But it is usually too small for user to input rapidly and correctly. Parts of providers provide external keypads which are easier for input but not easily to carry. Conventional foldable keypads are foldable to be smaller and therefore portable, but they provide only single input function as a normal keyboard.

Accordingly, a scope of the invention is to provide a foldable input apparatus with multiple detachable input devices to solve aforesaid problems.

### SUMMARY OF THE INVENTION

A scope of the invention is to provide a foldable input apparatus which can be either full-sized for input or folded up to be smaller for portability. Besides, the foldable input apparatus also has detachable input modules for additional operation when the foldable input apparatus is folded. Moreover, according to actual requirement, the user can use different input modules, such as a game operation module, a multimedia operation module, a touch-type input module, a display module, and the like. Thereby, the foldable input apparatus can be more versatile and more extensively applicable.

According to an embodiment of the invention, the foldable input apparatus includes a base, a holding plate and an input module. The base has a first surface, and a first set of keys is disposed on the first surface. The first holding plate has a second surface and a third surface. The first holding plate is pivotally connected to the base and therefore rotatable with respect to the base. A second set of keys is disposed on the second surface. A first recess is formed on the third surface, and a first circuit board is disposed in the first recess. A first input module is detachably mounted in the first recess so as to electrically connect with the first circuit board. When the first surface of the base and the second surface of the first holding plate lie in the same plane, the first set of keys and the second set of keys are operable to input data, and when the second surface of the first holding plate covers the first surface of the base, the first input module is operable.

Therefore, the foldable input apparatus according to the invention can be either full-sized for input or folded up to be smaller for portability. Besides, the foldable input apparatus also has detachable input modules for additional operation when the foldable input apparatus is folded. Moreover, according to actual requirement, the user can use different input modules, such as a game operation module, a multimedia operation module, a touch-type input module, a display module, and the like. Thereby, the foldable input apparatus can be more versatile and more extensively applicable.

The advantage and spirit of the invention may be understood by the following recitations together with the appended drawings.

### BRIEF DESCRIPTION OF THE APPENDED DRAWINGS

FIG. 1 shows an outside view of the foldable input apparatus according to an embodiment of the invention.

FIG. 2 shows an unfolded view of the foldable input apparatus shown in FIG. 1.

FIG. 3 shows a folded view of the foldable input apparatus shown in FIG. 1.

FIG. 4 shows an outside view of the foldable input apparatus shown in FIG. 3 as the first and second input modules serve as a game operation module.

FIG. 5 shows an outside view of the foldable input apparatus shown in FIG. 1 as it is connected to an electronic apparatus.

### DETAILED DESCRIPTION OF THE INVENTION

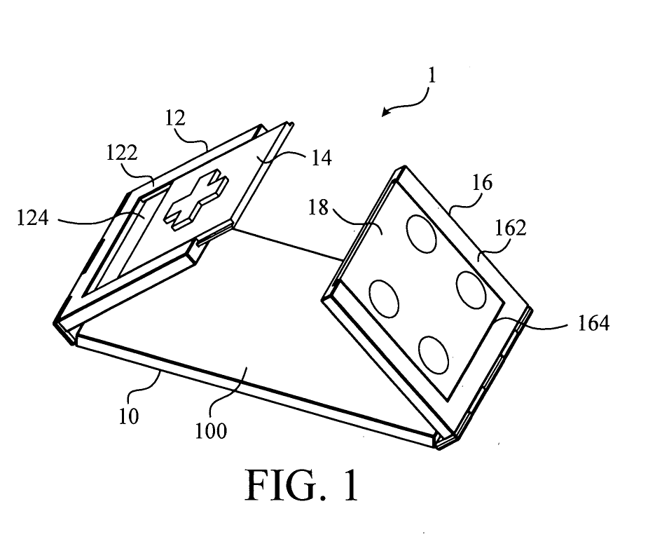

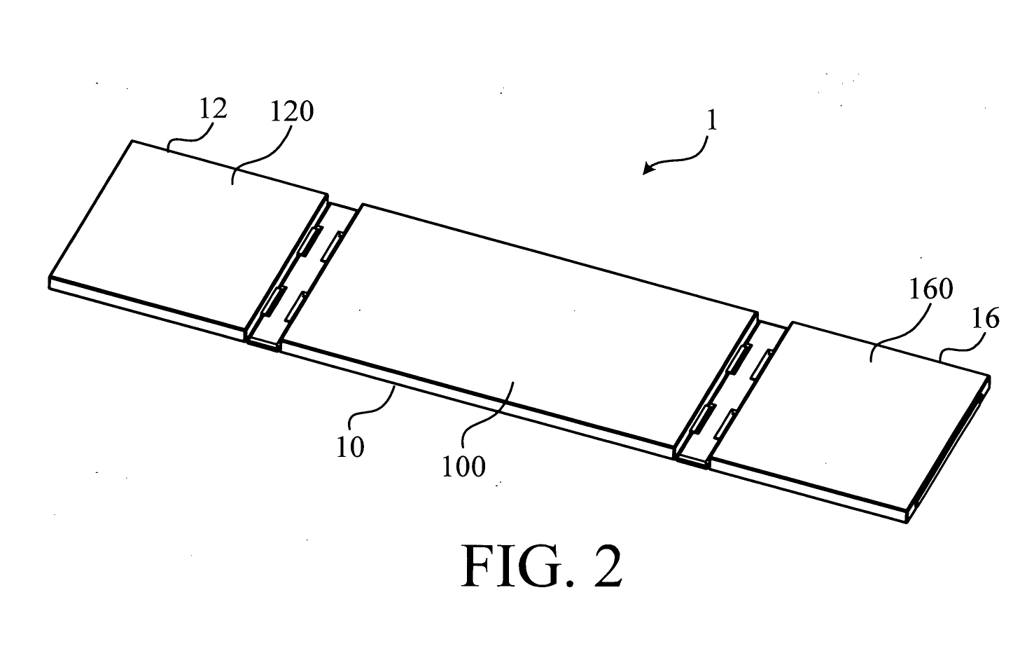

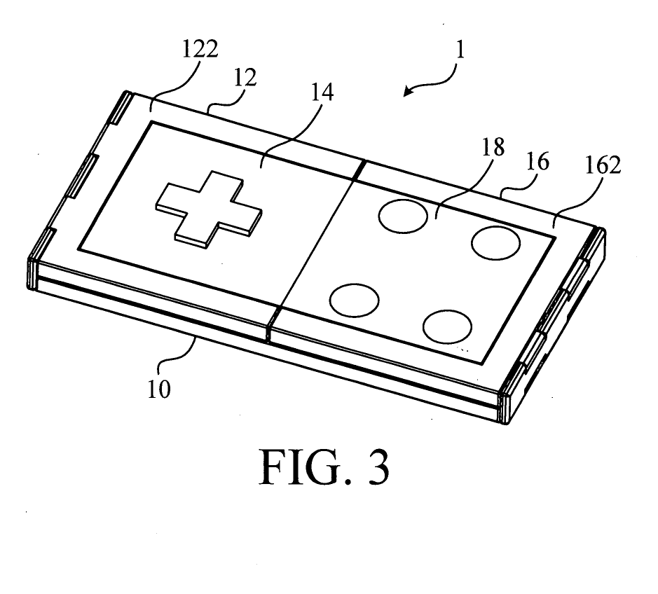

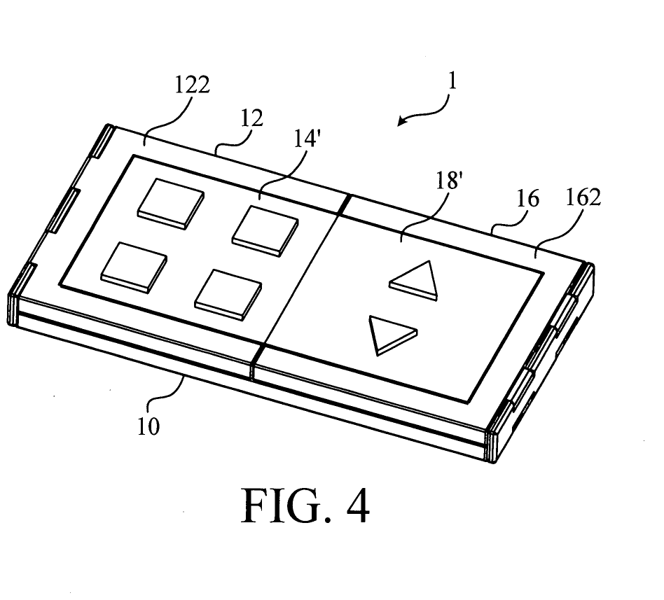

Please refer to FIG. 1 through FIG. 4. FIG. 1 shows an outside view of the foldable input apparatus 1 according to an embodiment of, the invention. FIG. 2 shows an unfolded view of the foldable input apparatus 1 shown in FIG. 1. FIG. 3 shows a folded view of the foldable input apparatus 1 shown in FIG. 1. FIG. 4 shows an outside view of the foldable input apparatus shown in FIG. 3 as the first input module 14 and second input module 18 serve as a game operation module. In the embodiment, a foldable input apparatus 1 is used for inputting data. As shown in FIG. 1, the foldable input apparatus 1 includes a base 10, a first holding plate 12, a first input module 14, a second holding plate 16 and a second input module 18. It is noticeable that the foldable input apparatus 1 can include only one holding plate and one input module, or it can also include more than two holding plates and input modules. It is decided by designers according to real applications.

As shown in FIG. 1, the base 10 has a first surface 100, and a first set of keys (not shown in FIG. 1) is disposed on the first surface 100. As shown in FIGS. 1 and FIG. 2, the first holding plate 12 has a second surface 120 and a third surface 122. The first holding plate 12 is pivotally connected to the base 10 and therefore rotatable with respect to the base 10. A second set of keys (not shown in FIG. 1) is disposed on the second surface 120. A first recess 124 is formed on the third surface 122, and a first circuit board (not shown in FIG. 1) is disposed in the first recess 124. A first input module 14 is detachably mounted in the first recess 124 so as to electrically connect with the first circuit board.

In the embodiment, a second holding plate 16 has a fourth surface 160 and a fifth surface 162, as shown in FIG. 1 and FIG. 2. The second holding plate 16, opposite to the first holding plate 12, is pivotally connected to the base 10 and therefore rotatable with respect to the base 10. A third set of keys (not shown) is disposed on the fourth surface 160. A second recess 164 is formed on the fifth surface 162, and a second circuit board (not shown) is disposed in the second recess 164. A second input module 18 is detachably mounted in the second recess 164 so as to electrically connect with the second circuit board.

As shown in FIG. 2, when the first surface 100 of the base 10, the second surface 120 of the first holding plate 12 and the fourth surface 160 of the second holding plate 16 lie in the same plane, the first set of keys, the second set of keys and the third set of keys are operable to input data. In other words, when a user rotates the first holding plate 12 and the second holding plate 16 to unfold the foldable input apparatus 1, the first set of keys, the second set of keys and the third set of keys constitute a full-size keypad, similar to a keyboard for a desktop PC, for the user to input.

As shown in FIG. 3, when the second surface 120 of the first holding plate 12 and the fourth surface 160 of the second holding plate 16 respectively cover the first surface 100 of the base 10, the first input module 14 and the second input module 18 are operable. In other words, when a user rotates the first holding plate 12 and the second holding plate 16 to fold the foldable input apparatus 1, the user can operate the first input module 14 and/or the second input module 18 to perform various applications.

In the embodiment, each of the first input module 14 and the second input module 18 can respectively be a game operation module, a multimedia operation module, a display module, or the like. And, a user can change the first input module 14 and the second input module 18 according to real applications. For example, when the first input module 14 and the second input module 18 of the foldable input apparatus 1 serve as a multimedia operation module, the user can operate the first input module 14 and the second input module 18 to operate the playing of multimedia objects, as shown in FIG. 3. When the first input module 14 and the second input module 18 of the foldable input apparatus 1 are replaced by a first input module 14′ and a second input module 18′ serving as a game operation module, the user can operate the first input module 14′ and the second input module 18′ to perform the operation of a game, as shown in FIG. 4.

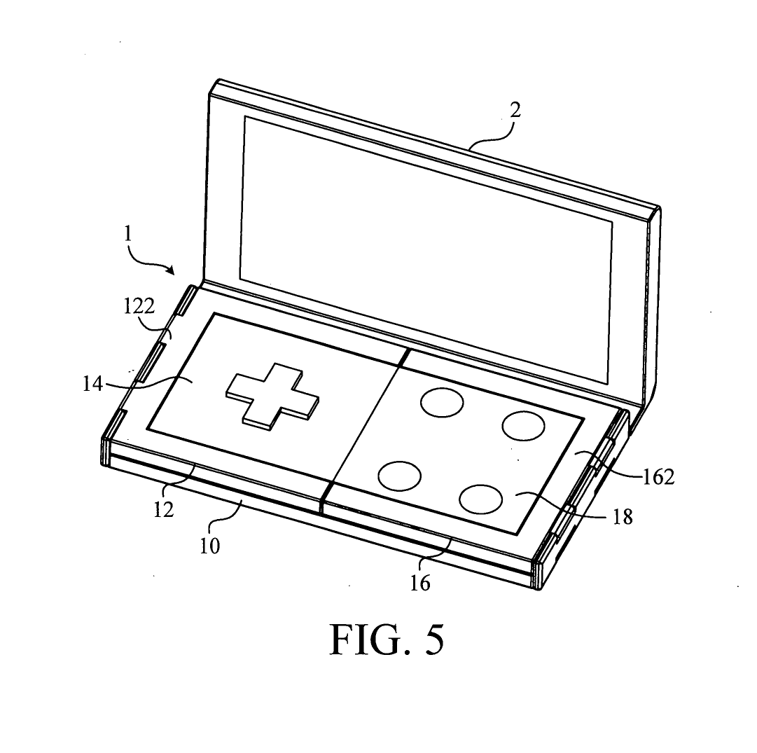

Please refer to FIG. 5. FIG. 5 shows an outside view of the foldable input apparatus 1 shown in FIG. 1 as it is connected to an electronic apparatus. In real applications, the foldable input apparatus 1 can further include a connection interface (not shown) connected to an electronic apparatus 2, as shown in FIG. 5. The connection interface can be a wireless connection interface or a wired connection interface, such as an Integrated Drive Electronics (IDE) interface, a Universal Serial Bus (USB) interface, an IEEE1394 interface, a Serial AT Attachment (SATA) interface, an Infrared Data Association (IrDA) interface, a Bluetooth interface, a Wi-Fi interface, a UWB interface, or the like. The electronic apparatus 2 can be a tablet PC, a notebook, a portable media player, a personal digital assistant, a mobile phone, or the like.

Comparing with prior arts, the foldable input apparatus according to the invention can be either full-sized for input or folded up to be smaller for portability. Besides, the foldable input apparatus also has detachable input modules for additional operation when the foldable input apparatus is folded. Moreover, according to actual requirement, the user can use different input modules, such as a game operation module, a multimedia operation module, a touch-type input module, a display module, and the like. Thereby, the foldable input apparatus can be more versatile and more extensively applicable.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A foldable input apparatus, comprising:
a base having a first surface, a first set of keys being disposed on the first surface;
a first holding plate having a second surface and a third surface, the first holding plate being pivotally connected to the base and therefore rotatable with respect to the base, a second set of keys being disposed on the second surface, a first recess being formed on the third surface, a first circuit board being disposed in the first recess; and
a first input module, detachably mounted in the first recess so as to electrically connect with the first circuit board;
wherein when the first surface of the base and the second surface of the first holding plate lie in the same plane, the first set of keys and the second set of keys are operable to input data, when the second surface of the first holding plate covers the first surface of the base, the first input module is operable.

2. The foldable input apparatus of claim 1, wherein the first input module is one selected from a group consisting of a game operation module, a multimedia operation module, a touch-type input module, and a display module.

3. The foldable input apparatus of claim 1, further comprising:
a second holding plate having a fourth surface and a fifth surface, the second holding plate, opposite to the first holding plate, being pivotally connected to the base and therefore rotatable with respect to the base, a third set of keys being disposed on the fourth surface, a second recess being formed on the fifth surface, a second circuit board being disposed in the second recess; and
a second input module detachably mounted in the second recess so as to electrically connect with the second circuit board;
wherein when the first surface of the base, the second surface of the first holding plate and the fourth surface of the second holding plate lie in the same plane, the first set of keys, the second set of keys and the third set of keys are operable to input data, when the second surface of the first holding plate and the fourth surface of the second holding plate respectively cover the first surface of the base, the first input module and the second input module are operable.

4. The foldable input apparatus of claim 3, wherein the second input module is one selected from a group consisting of a game operation module, a multimedia operation module, and touch-type input module, and a display module.

5. The foldable input apparatus of claim 1, further comprising a connection interface connected to an electronic apparatus.

6. The foldable input apparatus of claim 5, wherein the connection interface is a wireless connection interface.

7. The foldable input apparatus of claim 6, wherein the wireless connection interface is one selected from a group consisting of an Infrared Data Association (IrDA) interface, a Bluetooth interface, a Wi-Fi interface, and a UWB interface.

8. The foldable input apparatus of claim 5, wherein the connection interface is a wired connection interface.

9. The foldable input apparatus of claim 8, wherein the wired connection interface is one selected from a group consisting of an Integrated Drive Electronics (IDE) interface, a Universal Serial Bus (USB) interface, an IEEE1394 interface, and a Serial AT Attachment (SATA) interface.

10. The foldable input apparatus of claim 5, wherein the electronic apparatus is one selected from a group consisting of a tablet PC, a notebook, a portable media player, a personal digital assistant, and a mobile phone.
